(19) United States
(12) Patent Application Publication
(10) Pub. No.: US 2014/0063218 A1
(43) Pub. Date: Mar. 6, 2014

(54) ENDOSCOPE WITH UNIVERSAL SERIES BUS SIGNAL TRANSMISSION

(71) Applicant: WEI-TENG LIN, NEW TAIPEI CITY (TW)

(72) Inventor: WEI-TENG LIN, NEW TAIPEI CITY (TW)

(73) Assignee: PIONEER MEDICAL INSTRUMENT CO., LTD., NEW TAIPEI CITY (TW)

(21) Appl. No.: 13/604,630

(22) Filed: Sep. 6, 2012

(51) Int. Cl. H04N 7/18

(52) U.S. Cl. 348/75; 348/E07.085

(57) ABSTRACT

An endoscope with a USB signal transmission includes an exploring tube, a lens, an image sensing element and a USB chip. The image sensing element has an output circuit for outputting a series signal. The USB chip is coupled to an image sensing element. The series-to-universal series unit converts the series signal into a universal series bus signal. The power supply circuit supplies electric power to the image sensing element. The data transmission circuit transmits a universal series bus signal. The USP chip integrates the output circuit into a power supply circuit and a data transmission circuit of a USB specification and converts the series signal into the universal series bus signal.

### BACKGROUND OF THE INVENTION

1. Field of the Invention

The present invention relates to an endoscope, in particular to the endoscope with a universal series bus (USB) signal transmission.

2. Description of the Related Art

In general, an image sensing element of an endoscope includes an amplifier and an analog-to-digital converter (ADC) for converting an analog signal into a digital signal. The digital signal is transmitted to an image processor through a plurality of transmission circuits, and then the image processor transmits the signal (which can be a digital signal, or an analog signal converted from a digital signal) to a display screen for the display of an image. In addition, a power transmission circuit is required for supplying the required electric power to the image sensing element.

Therefore, the electric signal outputted from the image sensing element is transmitted through the plurality of transmission circuits and a plurality of transmission lines, thus incurring a complicated manufacturing process and a high cost. In addition, the endoscope contains the plurality of transmission lines, so that the tube diameter of the endoscope is increased significantly.

Furthermore, the electric signal outputted from the image sensing element is generally transmitted by the conventional transmission method, thus the transmission rate cannot be improved. When it is necessary to transmit high-pixel high-resolution image signals, the signals cannot be transmitted quickly, thus resulting to an image lag.

In view of the aforementioned drawbacks of the prior art, the inventor of the present invention conducted researches and experiments and invented the present invention to overcome the drawbacks of the prior art.

### SUMMARY OF THE INVENTION

In view of the problems of the prior art, it is a primary objective of the present invention to provide an endoscope with USB signal transmission, wherein an image sensing element is coupled to a USB chip in order to overcome the problems of having too many signals and power transmission circuits, too slow signal transmission rate, and too many electronic components occupied in the internal space of the endoscope, and the size of the endoscope cannot be reduced effectively.

Another objective of the present invention is to provide an endoscope with a USB signal transmission, wherein an electric signal outputted from the image sensing element can be transmitted through a three-dimensional circuit formed on a surface (such as a plastic curved surface) of an electric signal transmission member to solve the problem of a soldered or snapped-in circuit board that may fall out easily, and the electric signal can be connected to the plurality of transmission circuits, transmission lines and electronic components easily.

To achieve the foregoing objective, the present invention provides an endoscope with USB signal transmission comprising an exploring tube, a lens, an image sensing element and a USB chip. The lens is installed at a front end of the exploring tube. The image sensing element is disposed on a side of the lens and has a plurality of output circuits provided for outputting a series signal. The USB chip is coupled to the image sensing element and has a series-to-universal series unit, a plurality of power supply circuits and a plurality of data transmission circuits. The series-to-universal series unit is provided for converting the series signal of the image sensing element into a universal series bus signal. The plurality of power supply circuits is provided for supplying electric power to the image sensing element, and the plurality of data transmission circuits is provided for transmitting the universal series bus signal.

Wherein, the USB chip integrates the plurality of output circuits into a plurality of power supply circuits and a plurality of data transmission circuits with a USB specification and converts the series signal of the image sensing element into the universal series bus signal.

Wherein, the endoscope with USB signal transmission further comprises an electric signal transmission member, and the electric signal transmission member has a plurality of three-dimensional circuits disposed on a surface of the electric signal transmission member.

The technical contents of the present invention will become apparent with the detailed description of preferred embodiments and the illustration of related drawings as follows.

### BRIEF DESCRIPTION OF THE DRAWINGS

FIG. 1 is a schematic view of an endoscope with a USB signal transmission in accordance with a first preferred embodiment of the present invention;

FIG. 2 is an exploded view of an endoscope with a USB signal transmission in accordance with a second preferred embodiment of the present invention;

FIG. 3 is a perspective view of an endoscope with a USB signal transmission in accordance with the second preferred embodiment of the present invention;

FIG. 4 is a schematic view of an endoscope with a USB signal transmission in accordance with a third preferred embodiment of the present invention;

FIG. 5 is a schematic view of an endoscope with a USB signal transmission in accordance with a fourth preferred embodiment of the present invention; and

FIG. 6 is a schematic view of an endoscope with a USB signal transmission in accordance with a fifth preferred embodiment of the present invention.

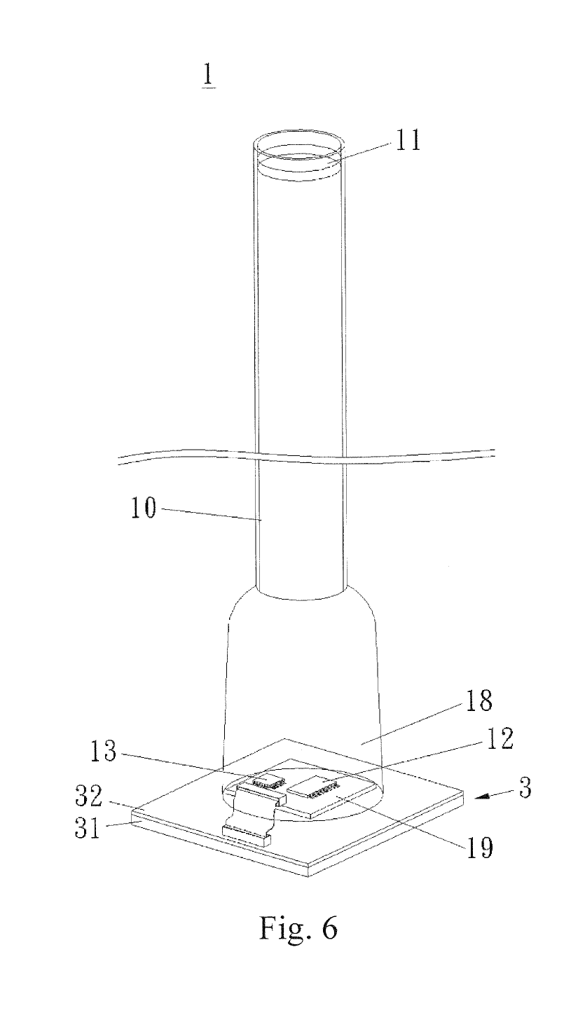

### DETAILED DESCRIPTION OF THE PREFERRED EMBODIMENTS

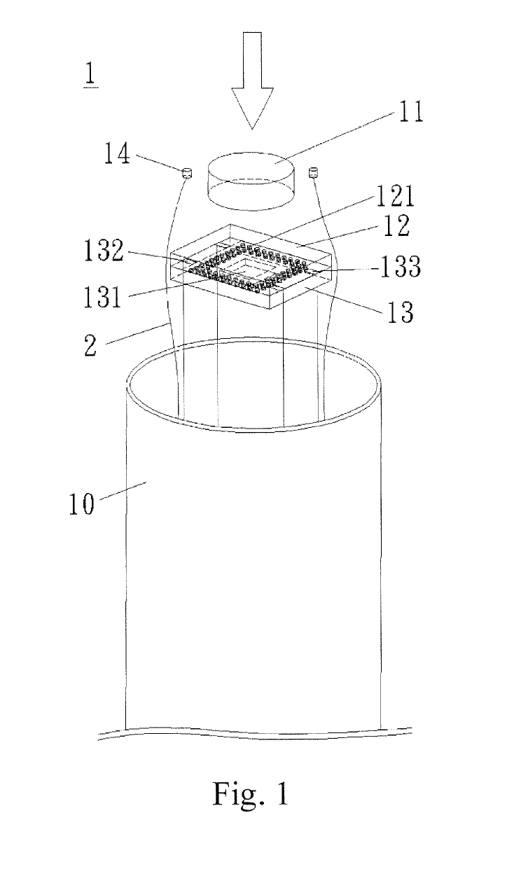

With reference to FIG. 1 for a schematic view of an endoscope with a USB signal transmission in accordance with the first preferred embodiment of the present invention, the endoscope 1 transmits an electric signal comprising a power signal and an electronic signal. The endoscope with a USB signal transmission 1 comprises an exploring tube 10, a lens 11, an image sensing element 12, a USB chip 13 and a light emitting element 14 (optional). The lens 11 is installed at a front end of the exploring tube 10.

The image sensing element 12 is disposed at the rear of the lens 11 and has a plurality of output circuits 121 for outputting a series signal. During an exposure process conducted by the image sensing element 12, an electric charge of each pixel is sequentially outputted to an amplifier of the image sensing element 12 for an amplification, and then outputted to an analog-to-digital converter (ADC) for converting the signal into a digital series signal, and then the series signal is outputted from the plurality of transmission circuits or the plurality of transmission lines.

The USB chip 13 is coupled to the image sensing element 12 and has a series-to-universal series unit 131, a plurality of power supply circuits 132 and a plurality of data transmission circuits 133, wherein the series-to-universal series unit 131 is provided for converting the series signal of the image sensing element 12 into a universal series bus signal, and the plurality of power supply circuits 132 is provided for supplying electric power to the image sensing element 12, and the plurality of data transmission circuits 133 is provided for transmitting the universal series bus signal and accelerating the transmission of the universal series bus signal.

In this preferred embodiment, the USB chip 13 is integrally coupled to the image sensing element 12. However, the invention is not limited to such arrangement only, and the USB chip 13 and the image sensing element 12 can be connected by circuits as well. The image sensing element 12 can be a chip, and the USB chip 13 and the image sensing element 12 can be integrated into a single chip, or the image sensing element 12 is manufactured as a chip and then coupled to the USB chip 13.

The specification of the USB chip 13 can be USB2.0, USB3.0 or USB4.0. In this preferred embodiment, the specification of the USB chip 13 is USB2.0 primarily having two data transmission circuits 133 (0 and 1 digital signals) and two power supply circuits 132 (anode and cathode).

Wherein, the plurality of output circuits 121 is integrated into a plurality of power supply circuits 132 and a plurality of data transmission circuits 133 of the USB specification through the USB chip 13, and the series signal of the image sensing element 12 is converted into a universal series bus signal by the USB chip 13.

In addition, the plurality of power supply lines 2 is provided for supplying electric power to a light emitting element 14 (such as a light emitting diode, LED).

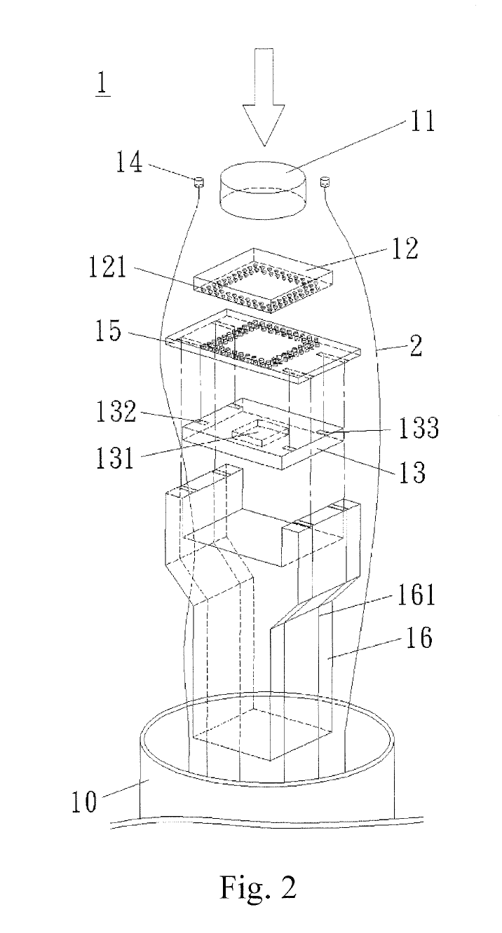

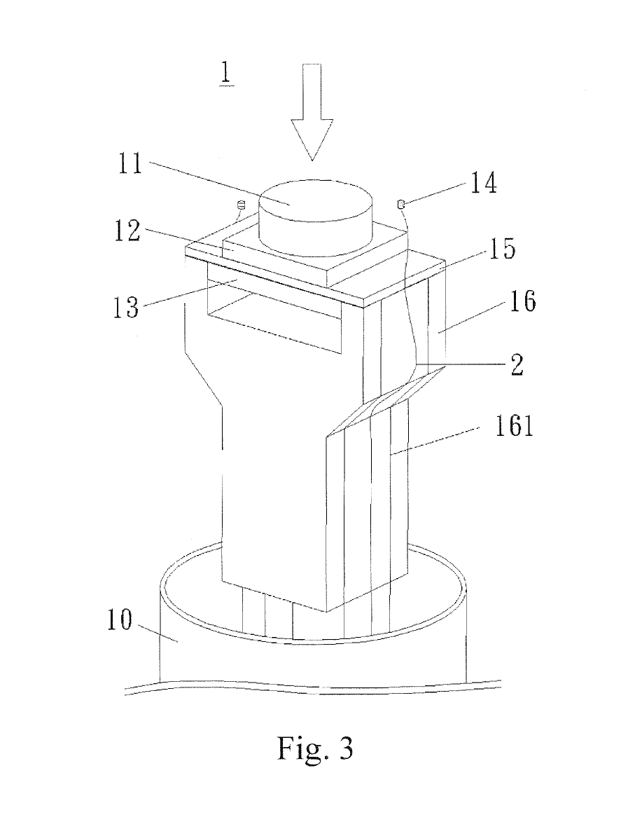

With reference to FIGS. 2 and 3 for an exploded view and a perspective view of an endoscope with a USB signal transmission in accordance with the second preferred embodiment of the present invention respectively, an electric signal of the endoscope with a USB signal transmission 1 includes a power signal and an electronic signal. The endoscope with a USB signal transmission 1 comprises an exploring tube 10, a lens 11, an image sensing element 12, a USB chip 13, and a light emitting element 14 (optional), a USB connecting base 15 and an electric signal transmission member 16. The lens 11 is installed at a front end of the exploring tube 10.

The image sensing element 12 is disposed at the rear of the lens 11 and has a plurality of output circuits 121 provided for outputting a series signal. During an exposure process conducted by the image sensing element 12, an electric charge of each pixel is sequentially outputted to an amplifier of the image sensing element 12 for an amplification, and then outputted to an analog-to-digital converter (ADC) to convert into a digital series signal, and then the series signal is outputted by the plurality of transmission circuits or the plurality of transmission lines.

The USB chip 13 is coupled to the image sensing element 12 and has a series-to-universal series unit 131, a plurality of power supply circuits 132 and a plurality of data transmission circuits 133, wherein the series-to-universal series unit 131 converts the series signal of the image sensing element 12 into a universal series bus signal, and the plurality of power supply circuits 132 supplies electric power to the image sensing element 12, and the plurality of data transmission circuits 133 transmits the universal series bus signal and accelerates the transmission of the universal series bus signal.

The specification of the USB chip 13 can be USB2.0, USB3.0 or USB4.0. In this preferred embodiment, the specification of the USB chip 13 is USB2.0 primarily having two data transmission circuits 133 (0 and 1 digital signals) and two power supply circuits 132 (anode and cathode).

An end surface of the USB connecting base 15 is coupled to the image sensing element 12, and the other end surface of the USB connecting base 15 is coupled to the USB chip 13 to reduce the tube diameter of the endoscope. Wherein, the circuit on the USB connecting base 15 is coupled to the USB chip 13 and the image sensing element 12.

The electric signal transmission member 16 has a plurality of three-dimensional circuits 161 disposed on a surface of the electric signal transmission member 16, and the plurality of three-dimensional circuits 161 is coupled to the plurality of data transmission circuits 133 and the plurality of power supply circuits 132 respectively, so that the plurality of three-dimensional circuits 161 can transmit an electronic signal. Wherein, the plurality of three-dimensional circuits 161 can be manufactured by a molded interconnect device (MID) process or a laser direct structuring (LDS) process. The three-dimensional circuit 161 is formed on a surface (such as a plastic curved surface) of the electric signal transmission member 16 to overcome the problem of the conventional soldered, adhered or snapped-in circuit board that may fall out easily. In addition, electric signals can be connected to the plurality of transmission circuits, transmission lines and electronic components easily so that components (such as the circuit boards) can be reduced.

Wherein, the plurality of output circuits 121 is integrated into a plurality of power supply circuits 132 and a plurality of data transmission circuits 133 of the USB specification by the USB chip 13, and the series signal of the image sensing element 12 is converted into a universal series bus signal by the USB chip 13. In addition, the plurality of power supply lines 2 can supply electric power to the light emitting element 14 (such as a light emitting diode, LED).

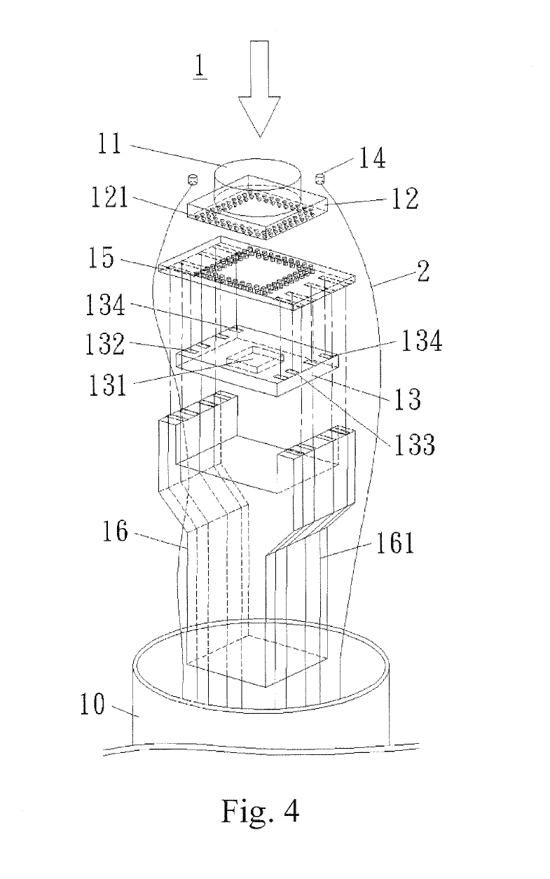

With reference to FIG. 4 for an endoscope with a USB signal transmission in accordance with the third preferred embodiment of the present invention, this embodiment as shown in FIG. 4 is substantially the same as the embodiment as shown in FIG. 2, and the description of the same elements and effects will not be repeated. One of the differences of the two embodiments resides on that the USB chip 13 of this embodiment is integrally coupled to the image sensing element 12 and the lens 11 to reduce the size and volume of the aforementioned components, so as to reduce the tube diameter of the endoscope significantly. In this preferred embodiment, a USB connecting base 15 is added for coupling the image sensing element 12 and the USB chip 13, but the invention is not limited to such arrangement only.

Another difference is that the USB chip 13 has a specification of USB3.0 primarily having two data transmission circuits 133, four super data transmission circuits 134 and two power supply circuits 132 (anode and cathode) and capable of providing a transmission rate of the image signal up to 5 Gbps, and the output of the electric power can be increased from 5V/500 mA to 5V/900 mA.

In addition, the plurality of power supply lines 2 can supply electric power to the light emitting element 14, but the invention is not limited to such arrangement. The plurality of power supply circuits 132 of USB3.0 also can supply electric power to the light emitting element 14 (such as the LED) as well.

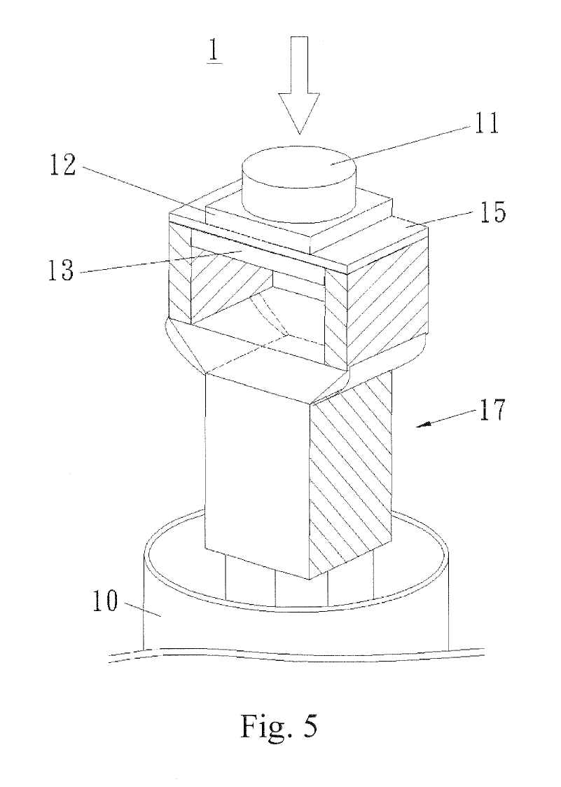

With reference to FIG. 5 for an endoscope with a USB signal transmission in accordance with the fourth preferred embodiment of the present invention, this embodiment as shown in FIG. 5 is substantially the same as the embodiment as shown in FIG. 2, and the endoscope with USB signal transmission 1 of this embodiment further comprises a first circuit board 17, and the USB chip 13 is coupled to a side of the first circuit board 17, wherein the first circuit board 17 can be a multi-layer circuit board, and circuits of the multi-layer circuit board are coupled to the plurality of data transmission circuits 133 respectively (as shown in FIG. 2) and the plurality of power supply circuits 132, so that the circuits of the multi-layer circuit board can be coupled to other electronic component for the transmission of data and electric power.

In this preferred embodiment, the multi-layer circuit board has an upper layer consisted of two rigid circuit hoards, a middle layer being a flexible telephony board, and a lower layer being a rigid circuit board. The upper-layer rigid circuit board is coupled to the flexible telephony board. The circuits on the upper-layer rigid circuit board are coupled to the USB connecting base 15 for connecting the plurality of data transmission circuits 133 and the plurality of power supply circuits 132 respectively, so that the circuits of the multi-layer circuit board can be coupled to other electronic components to provide a way of transmitting USB data and electric power (as shown in FIG. 2).

With reference to FIG. 5 for an endoscope with a USB signal transmission in accordance with the fifth preferred embodiment of the present invention, this embodiment as shown in FIG. 5 is substantially the same as the embodiment as shown in FIG. 2, and the endoscope with USB signal transmission 1 comprises an optical fiber in the exploring tube 10 to produce an optical fiber type endoscope, and the endoscope with USB signal transmission 1 further comprises a base 18.

The lens 11 is installed at a front end of the exploring tube 10. The image sensing element 12 is disposed at a rear end of the exploring tube 10.

The base 18 is disposed at an end of the exploring tube 10 and has a second circuit board 19 installed therein. The USB chip 13 and the image sensing element 12 are coupled to a side of the second circuit board 19, and both USB chip 13 and image sensing element 12 can be connected by a circuit or a transmission line. The image sensing element 12 and the USB chip 13 installed at the ends of the exploring tube 10 can reduce the components at the front end of the exploring tube 10 and the tube diameter of the exploring tube 10.

In addition, the endoscope with USB signal transmission can include a host 3 coupled to the base 18, and the host 3 includes a display unit 31 and a main circuit board 32, wherein the main circuit board 32 has electronic components installed thereon. The main circuit board 32 and the second circuit board 19 transmit the universal series bus signal and the electric power through the circuits respectively, and an image corresponding to the transmitted universal series bus signal is displayed on the display unit 31.

While the invention has been described by means of specific embodiments, numerous modifications and variations could be made thereto by those skilled in the art without departing from the scope and spirit of the invention set forth in the claims.

In summation of the description above, the present invention improves over the prior art and complies with patent application requirements, and thus is duly filed for patent application.

What is claimed is:

1. An endoscope with a universal series bus (USB) signal transmission, comprising:
an exploring tube;
a lens, installed at a front end of the exploring tube;
an image sensing element, disposed on a side of the lens, and having a plurality of output circuits provided for outputting a series signal; and
a USB chip, coupled to the image sensing element, and having a series-to-universal series unit, a plurality of power supply circuits and a plurality of data transmission circuits, and the series-to-universal series unit being provided for converting the series signal of the image sensing element into a universal series bus signal, and the plurality of power supply circuits being provided for supplying electric power to the image sensing element, and the plurality of data transmission circuits being provided for transmitting the universal series bus signal;
wherein, the USB chip integrates the plurality of output circuits into a plurality of power supply circuits and a plurality of data transmission circuits with a USB specification and converts the series signal of the image sensing element into the universal series bus signal.

2. The endoscope with a USB signal transmission according to claim 1, wherein the USB chip is integrally coupled to the image sensing element.

3. The endoscope with a USB signal transmission according to claim 1, wherein the USB chip is integrally coupled to the image sensing element and the lens.

4. The endoscope with a USB signal transmission according to claim 1, wherein the USB chip is made according to a specification selected from the collection of USB2.0, USB3.0 and USB4.0.

5. The endoscope with a USB signal transmission according to claim 1, further comprising a USB connecting base with an end surface coupled to the image sensing element and the other end surface coupled to the USB chip to reduce the tube diameter of the endoscope.

6. The endoscope with a USB signal transmission according to claim 1, further comprising a first circuit board, and the USB chip being coupled to a side of the first circuit board.

7. The endoscope with a USB signal transmission according to claim 1, further comprising a base disposed at an end of the exploring tube, and the base having a second circuit board installed therein, and the USB chip and the image sensing element being coupled to a side of the second circuit board.

8. The endoscope with a USB signal transmission according to claim 1, further comprising an electric signal transmission member, and the electric signal transmission member having a plurality of three-dimensional circuits installed on a surface of the electric signal transmission member, and the plurality of three-dimensional circuits being coupled to the plurality of corresponding data transmission circuits and the plurality of corresponding power supply circuits respectively, so that the plurality of three-dimensional circuits can transmit an electronic signal.

9. The endoscope with a USB signal transmission according to claim 1, wherein the plurality of power supply circuits supplies a portion of electric power to a light emitting element.
